(19) United States
(12) Patent Application Publication
(10) Pub. No.: US 2015/0235777 A1
(43) Pub. Date: Aug. 20, 2015

(54) POWER STORAGE DEVICE POSITIVE ELECTRODE, POWER STORAGE DEVICE, AND METHOD FOR PRODUCING SLURRY FOR POWER STORAGE DEVICE POSITIVE ELECTRODE

(71) Applicant: NITTO DENKO CORPORATION, Ibaraki-shi, Osaka (JP)

(72) Inventors: Yohei Ando, Ibaraki-shi (JP); Yutaka Kishii, Ibaraki-shi (JP); Masao Abe, Ibaraki-shi (JP); Yoshihiro Uetani, Ibaraki-shi (JP); Hiroyoshi Take, Ibaraki-shi (JP); Atsuko Mizuike, Ibaraki-shi (JP)

(73) Assignee: NITTO DENKO CORPORATION, Ibaraki-shi, Osaka (JP)

(21) Appl. No.: 14/417,862

(22) PCT Filed: Aug. 7, 2013
(86) PCT No.: PCT/JP2013/071423

§ 371 Date: Apr. 15, 2015

(30) Foreign Application Priority Data
Aug. 8, 2012 (JP) 2012-176310
Aug. 6, 2013 (JP) 2013-163440

(51) Int. Cl. H01G 11/42; C08G 73/02; H01G 11/66; H01M 4/60; H01G 11/04; H01G 11/28

(52) U.S. Cl. CPC H01G 11/42; H01G 11/04; H01G 11/28; H01G 11/66; H01M 4/606; C08G 73/0266

(57) ABSTRACT

A higher performance positive electrode for a power storage device is provided, which ensures a higher capacity density per unit weight of an active substance and, particularly, a higher initial capacity in initial charge/discharge. The power storage device positive electrode includes electrically conductive polymer particles as an active substance, and the electrically conductive polymer particles each have a flat shape.

### TECHNICAL FIELD

The present invention relates to a power storage device positive electrode, a power storage device, and a method for producing a slurry for the power storage device positive electrode. More specifically, the present invention relates to a power storage device positive electrode and a power storage device which have higher performance and ensure a higher initial capacity in initial charge/discharge, and a method for producing a slurry for the power storage device positive electrode.

### BACKGROUND ART

With recent improvement and advancement of electronics technology for mobile PCs, mobile phones, personal digital assistants (PDAs), etc., secondary batteries and the like which can be repeatedly charged and discharged are widely used as power storage devices for these electronic apparatuses. It is desirable to increase the capacity of an electrode material for these secondary batteries and other electrochemical power storage devices.

An electrode for such a power storage device contains an active substance which is capable of ion insertion/desertion. The ion insertion/desertion of the active substance is also referred to as doping/dedoping, and the doping/dedoping amount per unit molecular structure is referred to as dope percentage (or doping percentage). A material having a higher dope percentage can provide a higher capacity battery.

From an electrochemical viewpoint, the capacity of the battery can be increased by using an electrode material having a greater ion insertion/desertion amount. In lithium secondary batteries which are attractive power storage devices, more specifically, a graphite-based negative electrode capable of lithium ion insertion/desertion is used in which about one lithium ion is inserted and deserted with respect to six carbon atoms to provide a higher capacity.

Of these lithium secondary batteries, a lithium secondary battery which has a higher energy density and, therefore, is widely used as the power storage device for the aforesaid electronic apparatuses includes a positive electrode prepared by using a lithium-containing transition metal oxide such as lithium manganate or lithium cobaltate, and a negative electrode prepared by using a carbon material capable of lithium ion insertion/desertion, the positive electrode and the negative electrode being disposed in opposed relation in an electrolytic solution.

However, this lithium secondary battery, which generates electric energy through an electrochemical reaction, disadvantageously has a lower power density because of its lower electrochemical reaction rate. Further, the lithium secondary battery has a higher internal resistance, so that rapid discharge and rapid charge of the secondary battery are difficult. In addition, the secondary battery generally has a shorter service life, i.e., a poorer cycle characteristic, because the electrodes and the electrolytic solution are degraded due to the electrochemical reaction associated with the charge and the discharge.

There is also known a lithium secondary battery in which an electrically conductive polymer such as a polyaniline containing a dopant is used as a positive electrode active substance to cope with the aforesaid problem (see PLT1).

In general, however, the secondary battery employing the electrically conductive polymer as the positive electrode active substance is of anion migration type in which the electrically conductive polymer is doped with an anion in a charge period and dedoped with the anion in a discharge period. Where a carbon material or the like capable of lithium ion insertion/desertion is used as a negative electrode active substance, therefore, it is impossible to provide a rocking chair-type secondary battery of cation migration type in which the cation migrates between the electrodes in the charge/discharge. That is, the rocking chair-type secondary battery is advantageous in that only a smaller amount of the electrolytic solution is required, but the secondary battery employing the electrically conductive polymer as the positive electrode active substance cannot enjoy this advantage. Therefore, it is impossible to contribute to the size reduction of the power storage device.

To cope with this problem, a secondary battery of cation migration type is proposed which is substantially free from change in the ion concentration of the electrolytic solution without the need for a greater amount of the electrolytic solution, and aims at improving the capacity density and the energy density per unit volume or per unit weight. This secondary battery includes a positive electrode prepared by using an electrically conductive polymer containing a polymer anion such as polyvinyl sulfonate as a dopant, and a negative electrode of metal lithium (see PLT2).

### RELATED ART DOCUMENT

### Patent Document

PATENT DOCUMENT 1: JP-A-HEI3(1991)-129679

PATENT DOCUMENT 2: JP-A-HEI1(1989)-132052

### SUMMARY OF INVENTION

However, the secondary battery described above is still insufficient in performance. That is, the secondary battery is lower in capacity density and energy density than the lithium secondary battery which employs the lithium-containing transition metal oxide such as lithium manganate or lithium cobaltate for the positive electrode.

The battery described above fails to develop a sufficient capacity at the initial stage of the charge/discharge process immediately after the assembly of the battery, requiring to perform a troublesome low-rate (0.05 C) charge/discharge process several times.

In order to solve the aforementioned problems associated with the prior-art power storage devices such as the lithium secondary batteries, it is an object of the present invention to provide a power storage device positive electrode and a power storage device which have higher performance and ensure a higher capacity density per unit weight of an active substance and, particularly, a higher initial capacity in initial charge/discharge, and to provide a method for producing a slurry for the power storage device positive electrode.

According to a first aspect of the present invention to achieve the aforementioned object, there is provided a power storage device positive electrode, which includes particles of an electrically conductive polymer as an active substance, wherein the electrically conductive polymer particles each have a flat shape.

According to a second aspect, there is provided a power storage device, which includes an electrolyte layer, and a positive electrode and a negative electrode provided in opposed relation with the electrolyte layer interposed therebetween, wherein the positive electrode includes, as an active substance, particles of an electrically conductive polymer each having a flat shape.

According to a third aspect, there is provided a method for producing a slurry for a power storage device positive electrode, including the step of treating particles of an active substance including at least an electrically conductive polymer and a binder by a ball mill process.

The inventors of the present invention conducted intensive studies to provide a higher performance power storage device which has a higher capacity density per unit weight of an active substance and, particularly, a higher initial capacity in initial charge/discharge. In the studies, the inventors considered that the shapes of the electrically conductive polymer particles employed as the active substance significantly influence the capacity density, and further conducted studies. As a result of various experiments, the inventors found that, where electrically conductive polymer particles each having a flat shape are used as the active substance, a surprisingly higher initial capacity developing percentage can be achieved. This is supposedly, but not clearly, because the flat particles each have a shorter distance to an inner portion of the active substance and, therefore, an electrolytic solution and ions can be easily diffused into the inner portion of the active substance. It is noted that the flat shape is an elongated shape as seen in plan.

The power storage device positive electrode contains the electrically conductive polymer particles as the active substance, and the electrically conductive polymer particles each have a flat shape. Therefore, it is possible to provide a higher performance power storage device which has a higher capacity density per unit weight of the active substance and, particularly, a higher initial capacity in initial charge/discharge.

Where the electrically conductive polymer particles have an average aspect ratio (major diameter/minor diameter) of 3 to 10, it is possible to provide a higher performance power storage device having a further higher initial capacity.

Where the electrically conductive polymer is a polyaniline or a polyaniline derivative, it is possible to provide a higher performance power storage device having a further higher initial capacity.

Where the power storage device includes the electrolyte layer, and the positive electrode and the negative electrode provided in opposed relation with the electrolyte layer interposed therebetween, and the positive electrode includes, as the active substance, the electrically conductive polymer particles each having a flat shape, the power storage device has higher performance, a higher capacity density per unit weight of the active substance and, particularly, a higher initial capacity in initial charge/discharge.

Where the electrically conductive polymer particles have an average aspect ratio (major diameter/minor diameter) of 3 to 10 in the power storage device, the power storage device has higher performance and a further higher initial capacity.

Where the electrically conductive polymer is a polyaniline or a polyaniline derivative in the power storage device, the power storage device has a further higher capacity density per unit weight of the active substance and a further higher capacity density per unit volume of the positive electrode.

Where the particles of the active substance including at least the electrically conductive polymer and the binder are treated by the ball mill process in the method for producing the slurry for the power storage device positive electrode, it is possible to provide the desired flat particles of the electrically conductive polymer, and to provide the slurry for the power storage device positive electrode through a simplified process. Further, the power storage device employing the positive electrode produced from the slurry has higher performance and a higher initial capacity.

Where an electrically conductive agent and water are added to the active substance particles and the binder and the resulting mixture is treated by the ball mill process in the method for producing the slurry for the power storage device positive electrode, it is possible to provide the slurry for the positive electrode through a further simplified process without the need for separately adding the electrically conductive agent and the like.

Where the electrically conductive polymer is a polyaniline or a polyaniline derivative in the method for producing the slurry for the power storage device positive electrode, the power storage device has a further higher capacity density per unit weight of the active substance and a further higher capacity density per unit volume of the positive electrode.

Where milling balls to be used for the ball mill process each have a diameter of 0.2 to 4 mm in the method for producing the slurry for the power storage device positive electrode, the electrically conductive polymer particles of the slurry for the power storage device positive electrode each have a desired aspect ratio.

### BRIEF DESCRIPTION OF DRAWINGS

FIG. 1 is a sectional view of an exemplary power storage device.

FIGS. 2A to 2C are scanning electron microscope (SEM) photographs of dry products of positive electrode slurries for use in Examples 1 to 3.

FIGS. 3A to 3D are scanning electron microscope (SEM) photographs of dry products of positive electrode slurries for use in Comparative Examples 2 to 5.

FIGS. 4A to 4C are transmissive electron microscope (TEM) photographs of sectional surfaces of cured resin products each prepared by dispersing the positive electrode slurry in a resin for use in Examples 1 to 3.

FIGS. 5A to 5E are transmissive electron microscope (TEM) photographs of sectional surfaces of cured resin products each prepared by dispersing the positive electrode slurry in a resin for use in Comparative Examples 1 to 5.

FIG. 6 is a scanning electron microscope (SEM) photograph of a sectional surface of a positive electrode of Example 4.

### DESCRIPTION OF EMBODIMENTS

An embodiment of the present invention will hereinafter be described in detail by way of example but not by way of limitation.

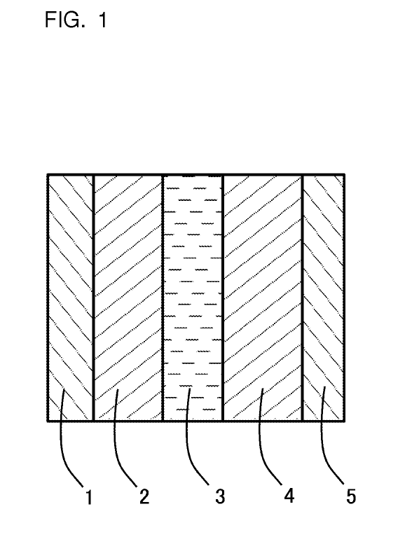

A power storage device positive electrode (hereinafter sometimes referred to simply as “positive electrode”) includes, as an active substance, particles of an electrically conductive polymer each having a flat shape. As shown in FIG. 1, a power storage device generally includes an electrolyte layer 3, and a positive electrode 2 and a negative electrode 4 provided in opposed relation with the electrolyte layer 3 interposed therebetween, and the power storage device positive electrode is used as the positive electrode 2 of the power storage device. The positive electrode, the electrolyte layer and the negative electrode will be successively described.

### <Positive Electrode>

The positive electrode contains the flat particles of the electrically conductive polymer as the active substance. That is, the positive electrode active substance, which has an electrical conductivity variable due to ion insertion/desertion, is an electrically conductive polymer.

### [Electrically Conductive Polymer]

The electrically conductive polymer is herein defined as any of polymers which have an electrical conductivity variable due to insertion or desertion of ion species with respect to the polymer in order to compensate for change in electric charge to be generated or removed by an oxidation reaction or a reduction reaction occurring in a main chain of the polymer.

The polymer has a higher electrical conductivity in a doped state, and has a lower electrical conductivity in a dedoped state. Even if the electrically conductive polymer loses its electrical conductivity due to the oxidation reaction or the reduction reaction to be thereby electrically insulative (in the dedoped state), the polymer can reversibly have an electrical conductivity again due to the oxidation/reduction reaction. Therefore, the electrically insulative polymer in the dedoped state is herein also classified into the category of the electrically conductive polymer.

A preferred example of the electrically conductive polymer is a polymer containing a dopant of a protonic acid anion selected from the group consisting of inorganic acid anions, aliphatic sulfonate anions, aromatic sulfonate anions, polymeric sulfonate anions and polyvinyl sulfate anion. Another preferred example of the electrically conductive polymer is a polymer obtained in the dedoped state by dedoping the electrically conductive polymer described above.

Specific examples of the electrically conductive polymer include electrically conductive polymer materials such as polyacetylene, polypyrrole, polyaniline, polythiophene, polyfuran, polyselenophene, polyisothianaphthene, polyphenylene sulfide, polyphenylene oxide, polyazulene, poly(3,4-ethylenedioxythiophene) and substitution products of these polymers, and carbon materials such as polyacene, graphite, carbon nanotube, carbon nanofiber and graphene. Particularly, polyaniline, polyaniline derivatives, polypyrrole and polypyrrole derivatives each having a higher electrochemical capacity are preferably used, and polyaniline and polyaniline derivatives are further preferably used.

Polyaniline is a polymer prepared by electrolytic polymerization or chemical oxidation polymerization of aniline, and the polyaniline derivatives are polymers prepared by electrolytic polymerization or chemical oxidation polymerization of aniline derivatives.

Examples of the aniline derivatives include aniline derivatives prepared by substituting aniline at positions other than the 4-position thereof with at least one substituent selected from the group consisting of alkyl groups, alkenyl groups, alkoxy groups, aryl groups, aryloxy groups, alkylaryl groups, arylalkyl groups and alkoxyalkyl groups. Specific examples of the aniline derivatives include o-substituted anilines such as o-methylaniline, o-ethylaniline, o-phenylaniline, o-methoxyaniline and o-ethoxyaniline, and m-substituted anilines such as m-methylaniline, m-ethylaniline, m-methoxyaniline, m-ethoxyaniline and m-phenylaniline, which may be used either alone or in combination. Though having a substituent at the 4-position, p-phenylaminoaniline is advantageously used as the aniline derivative because polyaniline can be provided by the oxidation polymerization of p-phenylaminoaniline.

“Aniline or an aniline derivative” is herein referred to simply as “aniline” unless otherwise specified. “At least one of the polyaniline and the polyaniline derivative” is herein referred to simply as “polyaniline” unless otherwise specified. Even if a polymer for the electrically conductive polymer is prepared from an aniline derivative, therefore, the resulting polymer is referred to as “electrically conductive polyaniline.”

### [Preparation of Electrically Conductive Polymer]

As well known, the electrically conductive polyaniline can be prepared by electrolytic polymerization of aniline in a proper solvent in the presence of a protonic acid or by chemical oxidation polymerization of aniline with the use of an oxidizing agent. Preferably, the electrically conductive polyaniline is prepared by the oxidation polymerization of aniline in a proper solvent in the presence of a protonic acid with the use of an oxidizing agent. In general, water is used as the solvent, but other usable examples of the solvent include solvent mixtures of water soluble organic solvents and water, and solvent mixtures of water and nonpolar organic solvents. In this case, a surface active agent is used in combination with the solvent.

More specifically, where water is used as the solvent for the oxidation polymerization of aniline, for example, aniline is polymerized in water in the presence of a protonic acid with the use of a chemical oxidizing agent through the chemical oxidation polymerization. The chemical oxidation agent may be water-soluble or water-insoluble.

Preferred examples of the oxidizing agent include ammonium peroxodisulfate, hydrogen peroxide, potassium bichromate, potassium permanganate, sodium chlorate, cerium ammonium nitrate, sodium iodate and iron chloride.

The amount of the oxidizing agent to be used for the oxidation polymerization of aniline is related to the yield of the electrically conductive polyaniline. For stoichiometric reaction of aniline, the oxidizing agent is preferably used in an amount (2.5/n) times the molar amount of aniline to be used, wherein n is the number of electrons required for the reduction of one mole of the oxidizing agent. In the case of ammonium peroxodisulfate, for example, nis 2 as can be understood from the following reaction formula:

(NH₄)₂S₂O₈+2e→2NH₄⁺+2SO₄²⁻

However, the amount of the oxidizing agent to be used may be slightly smaller than the amount (2.5/n) times the molar amount of aniline to be used, i.e., 30 to 80% of the amount (2.5/n) times the molar amount of aniline to be used, for suppression of peroxidization of the polyaniline.

In the production of the electrically conductive polyaniline, the protonic acid serves to dope the produced polyaniline for imparting the polyaniline with electrical conductivity and for dissolving aniline in the form of salt in water. The protonic acid also serves to maintain the polymerization reaction system at a strong acidity level, preferably, with a pH of not higher than 1. Therefore, the amount of the protonic acid is not particularly limited in the production of the electrically conductive polyaniline, as long as the above purposes can be achieved. In general, the amount of the protonic acid is 1.1 to 5 times the molar amount of aniline. If the amount of the protonic acid is excessively great, the costs of a waste liquid treatment required after the oxidation polymerization of aniline is needlessly increased. Therefore, the amount of the protonic acid is preferably 1.1 to 2 times the molar amount of aniline. Thus, a protonic acid having a strong acidity and an acid dissociation constant pKa of less than 3.0 is preferably used.

Preferred examples of the protonic acid having an acid dissociation constant pKa of less than 3.0 include inorganic acids such as sulfuric acid, hydrochloric acid, nitric acid, perchloric acid, tetrafluoroboric acid, hexafluorophosphoric acid, hydrofluoric acid and hydroiodic acid, aromatic sulfonic acids such as benzenesulfonic acid and p-toluenesulfonic acid, and aliphatic sulfonic acids (or alkanesulfonic acids) such as methanesulfonic acid and ethanesulfonic acid. Further, a polymer having a sulfonic acid group in its molecule, i.e., a polymer sulfonic acid, is also usable. Examples of the polymer sulfonic acid include polystyrene sulfonic acid, polyvinyl sulfonic acid, polyallyl sulfonic acid, poly(acrylamide-t-butylsulfonic acid), phenol sulfonic acid novolak resin, and perfluorosulfonic acid such as NAFION (registered trade name). Polyvinyl sulfuric acid is also usable as the protonic acid.

Other examples of the protonic acid to be used for the production of the electrically conductive polyaniline include some kinds of phenols such as picric acid, some kinds of aromatic carboxylic acids such as m-nitrobenzoic acid, and some kinds of aliphatic carboxylic acids such as dichloroacetic acid and malonic acid, which each have an acid dissociation constant pKa of less than 3.0.

Of the various protonic acids described above, tetrafluoroboric acid and hexafluorophosphoric acid are preferably used, because they are protonic acids containing the same anion species as an electrolyte salt (base metal salt) used for a nonaqueous electrolytic solution in a nonaqueous electrolytic secondary battery and, more specifically, they are protonic acids each containing the same anion species as an electrolyte salt (lithium salt) used for a nonaqueous electrolytic solution in a lithium secondary battery.

As described above, the electrically conductive polymer may be a polymer doped with a protonic acid anion or may be a dedoped polymer obtained by dedoping a polymer doped with a protonic acid anion. As required, the dedoped polymer may be further subjected to a reduction process.

An exemplary method for dedoping the electrically conductive polymer is such that the electrically conductive polymer doped with the protonic acid anion is neutralized with an alkali. An exemplary method for performing the reduction process after the dedoping of the electrically conductive polymer doped with the protonic acid anion is such that the electrically conductive polymer doped with the protonic acid anion is neutralized with an alkali and then dedoped, and the resulting dedoped polymer is reduced with a reducing agent.

Where the electrically conductive polymer doped with the protonic acid anion is neutralized with the alkali, for example, the electrically conductive polymer is fed into an alkali aqueous solution such as a sodium hydroxide aqueous solution, a potassium hydroxide aqueous solution or ammonia water and the resulting mixture is stirred at a room temperature or, as required, with heating to about 50° C. to about 80° C. The dedoping reaction of the electrically conductive polymer is promoted by the alkali treatment with heating, so that the dedoping can be completed in a shorter period of time.

Where the dedoped polymer is reduced as described above, on the other hand, the dedoped polymer is fed into a reducing agent solution such as a hydrazine hydrate aqueous solution, a phenylhydrazine alcohol solution, a sodium dithionite aqueous solution or a sodium sulfite aqueous solution and the resulting mixture is stirred at a room temperature or, as required, with heating to about 50° C. to about 80° C.

As required, a binder, an electrically conductive agent, water and the like may be further added to the electrically conductive polymer for the positive electrode material. Particularly, an anionic material also functioning as the binder is preferred because the capacity density can be increased.

### [Anionic Material]

Examples of the anionic material include anionic polymers, anionic compounds each having a relatively great molecular weight, and anionic compounds each having a lower solubility in an electrolytic solution. More specifically, a compound having a carboxyl group in its molecule is preferably used and, particularly, a polymeric polycarboxylic acid is preferably used. Where the polycarboxylic acid is used as the anionic material, the polycarboxylic acid functions as the binder as well as the dopant, thereby improving the characteristic properties of the power storage device.

Examples of the polycarboxylic acid include polyacrylic acid, polymethacrylic acid, polyvinylbenzoic acid, polyallylbenzoic acid, polymethallylbenzoic acid, polymaleic acid, polyfumaric acid, polyglutamic acid and polyasparaginic acid, among which polyacrylic acid and polymethacrylic acid are particularly preferred. These polycarboxylic acids may be used either alone or in combination.

The polycarboxylic acid may be a polycarboxylic acid of lithium-exchanged type prepared by lithium-exchanging carboxyl groups of a carboxyl-containing compound. The lithium exchange percentage is preferably 100%, but may be lower (preferably 40% to 100%) according to the conditions.

The anionic material is generally used in an amount of 1 to 100 parts by weight, preferably 2 to 70 parts by weight, most preferably 5 to 40 parts by weight, based on 100 parts by weight of the electrically conductive polymer. If the amount of the anionic material is excessively small with respect to the electrically conductive polymer, it will be impossible to provide a power storage device having a higher capacity density. If the amount of the anionic material is excessively great with respect to the electrically conductive polymer, on the other hand, the relative amount of the active substance material is reduced, making it impossible to provide a power storage device having a higher capacity density.

Besides the anionic material described above, polyvinylidene fluoride or the like, for example, may be used as the binder in combination with the electrically conductive polymer.

The electrically conductive agent is desirably an electrically conductive material which has a higher electrical conductivity, and is effective for reducing the electrical resistance between the active substances of the battery and free from change in its properties due to application of a potential in battery discharge. Generally usable examples of the electrically conductive agent include electrically conductive carbon blacks such as acetylene black and Ketjen black, and fibrous carbon materials such as carbon fibers and carbon nanotubes.

### [Production of Positive Electrode]

Prior to description of the production of the positive electrode, the preparation of the flat particles of the electrically conductive polymer and the preparation of the slurry for the positive electrode will be described.

The electrically conductive polymer is generally prepared in a particulate form (in the form of coarse particles) but not in the form of flat particles. Therefore, the flat particles of the electrically conductive polymer are prepared with the use of a milling machine. The flat electrically conductive polymer particles preferably have an average aspect ratio (major diameter/minor diameter) of 3 to 10, more preferably 4 to 8, particularly preferably 5 to 6. If the average aspect ratio is less than the aforementioned lower limit, the initial capacity developing percentage of the power storage device tends to be reduced. If the average aspect ratio is greater than the aforementioned upper limit, on the other hand, the handling tends to be difficult because of the hazardous shape of the particles.

The average aspect ratio is determined by measuring the aspect ratios of all particles of the electrically conductive polymer appearing in a TEM photograph taken by a transmissive electron microscope (TEM) and averaging the aspect ratios thus measured. The number of the particles for the measurement is not less than 500, and the electrically conductive polymer particles present in the photograph need to be properly dispersed.

Any milling machine may be used, as long as the flat particles can be provided by milling the coarse particles with a milling force. Examples of the milling machine include a ball mill, a bead mill, a sand mill, an attritor and a roll mill. For efficient production of the flat particles by milling the coarse particles, a wet type ball mill is desirably used as the milling machine. An exemplary commercially available milling machine is P-6 available from Fritsch GMbh.

The milling process such as the ball mill process is generally performed at a room temperature (25° C.).

With the use of the milling machine, the coarse particles as the material for the positive electrode slurry is preferably treated together with the other slurry materials (the electrically conductive agent, the binder, water and the like). Thus, the flat particles of the electrically conductive polymer are provided and, at the same time, the positive electrode slurry is provided. Thus, this process is simplified. Further, it is preferred to treat only the coarse particles and the binder by the ball mill process and, after the ball mill process, the other materials such as the electrically conductive agent are added to the resulting mixture. Where the electrically conductive agent is localized to some extent, the capacity density can be increased.

The milling balls to be used for the ball mill process preferably each have a diameter of 0.2 to 4 mm, more preferably 0.3 to 3 mm, particularly preferably 0.5 to 2 mm. If the diameter is less than the aforementioned lower limit or greater than the aforementioned upper limit, it will be impossible to provide the flat particles of the electrically conductive polymer.

The ball mill process has less restriction on viscosity. Therefore, even if the coarse particles are present in a higher concentration, the ball mill process can provide the flat particles. The mixing ratio between the coarse particles and the other slurry materials (the binder and the like) may be properly set, but preferably 5/95 to 40/60, more preferably 10/90 to 20/80.

The flat particles of the electrically conductive polymer preferably have an average major diameter of 0.01 to 1000 μm, more preferably 0.1 to 100 μm, particularly preferably 1 to 20 μm, and preferably have an average minor diameter of 0.01 to 500 μm, more preferably 0.01 to 100 μm, particularly preferably 0.1 to 5 μm.

For the production of the positive electrode, the positive electrode slurry is prepared. The preparation of the flat particles of the electrically conductive polymer is more preferably achieved simultaneously with the preparation of the positive electrode slurry. Another exemplary preparation method is such that the anionic material is dissolved or dispersed in water, and the flat particles of the electrically conductive polymer and, as required, the electrically conductive agent such as electrically conductive carbon black are added to and sufficiently dispersed in the resulting solution or dispersion to prepare a slurry having a solution viscosity of about 0.1 to about 50 Pa·s.

The positive electrode slurry thus prepared is applied on a current collector or the like, and then water is evaporated from the slurry, whereby a sheet electrode, i.e., the positive electrode, is produced as a composite product (porous sheet) having a layer containing the positive electrode active substance.

The positive electrode thus produced is composed of at least the electrically conductive polymer particles, and preferably formed in a porous sheet. The positive electrode preferably has a thickness of 1 to 500 μm, more preferably 10 to 300 μm.

The thickness of the positive electrode is measured by means of a dial gage (available from Ozaki Mfg. Co., Ltd.) which is a flat plate including a distal portion having a diameter of 5 mm. The measurement is performed at ten points on a surface of the electrode, and the measurement values are averaged. Where the positive electrode (porous layer) is provided on the current collector (aluminum foil) to be combined with the current collector, the thickness of the combined product is measured in the aforementioned manner, and the measurement values are averaged. Then, the thickness of the positive electrode is determined by subtracting the thickness of the aluminum foil from the average thickness of the combined product.

Where the positive electrode containing the anionic material is produced, the anionic material is mixed with the electrically conductive polymer particles to form a mixture layer to be thereby fixed in the positive electrode. The anionic material fixed around the electrically conductive polymer particles serves for compensation for electric charge in the oxidation and the reduction of the electrically conductive polymer.

### <Electrolyte Layer>

The electrolyte layer is formed from an electrolyte. For example, a sheet including a separator impregnated with an electrolytic solution or a sheet made of a solid electrolyte is preferably used. The sheet made of the solid electrolyte per se functions as a separator.

The electrolyte includes a solute and, as required, a solvent and additives. Preferred examples of the solute include compounds prepared by combining a metal ion such as a lithium ion with a proper counter ion such as a sulfonate ion, a perchlorate ion, a tetrafluoroborate ion, a hexafluorophosphate ion, a hexafluoroarsenic ion, a bis(trifluoromethanesulfonyl)imide ion, a bis(pentafluoroethanesulfonyl)imide ion or a halide ion. Specific examples of the electrolyte include LiCF₃SO₃, LiClO₄, LiBF₄, LiPF₆, LiAsF₆, LiN(SO₂CF₃)₂, LiN(SO₂C₂F₅)₂ and LiCl.

Examples of the solvent to be used as required include nonaqueous solvents, i.e., organic solvents, such as carbonates, nitriles, amides and ethers. Specific examples of the organic solvents include ethylene carbonate, propylene carbonate, butylene carbonates, dimethyl carbonate, diethyl carbonate, ethyl methyl carbonate, acetonitrile, propionitrile, N,N′-dimethylacetamide, N-methyl-2-pyrrolidone, dimethoxyethane, diethoxyethane and γ-butyrolactone, which may be used either alone or in combination. A solution prepared by dissolving the solute in the solvent may be referred to as “electrolytic solution.”

In this embodiment, the separator can be used in a variety of forms as described above. The separator may be an insulative porous sheet which is capable of preventing an electrical short circuit between the positive electrode and the negative electrode disposed in opposed relation with the separator interposed therebetween and electrochemically stable and has a higher ionic permeability and a certain mechanical strength. Therefore, exemplary materials for the separator include paper, nonwoven fabric, porous films made of a resin such as polypropylene, polyethylene or polyimide, which may be used either alone or in combination.

### <Negative Electrode>

The negative electrode is preferably produced from a metal or a negative electrode material (negative electrode active substance) capable of ion insertion/desertion. Examples of the negative electrode active substance include metal lithium, carbon materials and transition metal oxides capable of insertion and desertion of lithium ions in oxidation and reduction, silicon and tin. The negative electrode preferably has substantially the same thickness as the positive electrode.

### <Positive Electrode Current Collector and Negative Electrode Current Collector>

Exemplary materials for the positive electrode current collector and the negative electrode current collector include metal foils and meshes such as of nickel, aluminum, stainless steel and copper. The positive electrode current collector and the negative electrode current collector may be formed of the same material or may be formed of different materials.

### <Production of Power Storage Device>

The production of the power storage device from the aforementioned materials will be described with reference to FIG. 1. The power storage device is preferably assembled in a glove box in an inert gas atmosphere such as an ultrapure argon gas atmosphere.

In FIG. 1, metal foils or meshes such as of nickel, aluminum, stainless steel or copper are used as current collectors (1, 5 in FIG. 1) for a positive electrode 2 and a negative electrode 4. Current extraction connection terminals (tab electrodes not shown) of the positive electrode and the negative electrode are respectively connected to the current collectors 1, 5 by means of a spot welding machine.

A predetermined number of various separators (not shown) are provided between the positive electrode 2 and the negative electrode 4. Then, the resulting assembly is put in a laminate cell having three heat-sealed sides, and the position of the separators is adjusted so that the positive electrode 2 and the negative electrode 4 are properly opposed to each other without short circuit.

In turn, a sealant is applied on tabs of the positive electrode and the negative electrode, and the tab electrode portions are heat-sealed with an electrolytic solution inlet port kept open. Thereafter, a predetermined amount of a battery electrolytic solution is sucked into a micropipette, and fed into the laminate cell through the electrolytic solution inlet port. Finally, the electrolytic solution inlet port provided at an upper portion of the laminate cell is heat-sealed, whereby the power storage device (laminate cell) is completed.

Besides the laminate cell, the power storage device thus provided may be shaped in a film form, a sheet form, a square form, a cylindrical form or a button form. In the case of the laminate cell, the positive electrode of the power storage device preferably has an edge length of 1 to 300 mm, particularly preferably 10 to 50 mm, and the negative electrode preferably has an edge length of 1 to 400 mm, particularly preferably 10 to 60 mm. The negative electrode preferably has a slightly greater size than the positive electrode.

The use of the flat particles makes it possible to develop a capacity at the initial stage of the charge/discharge process. This is supposedly because the flat shape of the particles improves ion diffusability into an inner portion of the active substance, and increases the contact percentage of the electrically conductive polymer particles.

The power storage device, like the electric double layer capacitor, has a higher weight power density and excellent cycle characteristics. In addition, the power storage device has a significantly higher weight energy density than the prior art electric double layer capacitor. Therefore, the power storage device may be a kind of a capacitor-type power storage device.

### EXAMPLES

Inventive examples will hereinafter be described in conjunction with comparative examples. However, the present invention is not limited to these examples.

The following components were prepared before the production of power storage devices according to the inventive examples and the comparative examples.

### <Preparation of Electrically Conductive Polyaniline Powder>

Powder of an electrically conductive polyaniline (electrically conductive polymer) containing tetrafluoroboric acid as a dopant was prepared in the following manner. The powder herein means agglomerated particles, i.e., secondary particles generally resulting from agglomeration of primary particles. That is, 84.0 g (0.402 mol) of a tetrafluoroboric acid aqueous solution (special grade reagent available from Wako Pure Chemical Industries, Ltd.) having a concentration of 42 wt % was added to 138 g of ion-exchanged water contained in a 300-mL volume glass beaker. Then, 10.0 g (0.107 mol) of aniline was added to the resulting solution, while the solution was stirred by a magnetic stirrer. Immediately after the addition of aniline to the tetrafluoroboric acid aqueous solution, aniline was dispersed in an oily droplet form in the tetrafluoroboric acid aqueous solution, and then dissolved in water in several minutes to provide a homogeneous transparent aniline aqueous solution. The aniline aqueous solution thus provided was cooled to −4° C. or lower with the use of a cryostat chamber.

Then, 11.63 g (0.134 mol) of a powdery manganese dioxide oxidizing agent (Grade-1 reagent available from Wako Pure Chemical Industries, Ltd.) was added little by little to the aniline aqueous solution, while the mixture in the beaker was kept at a temperature of not higher than −1° C. Immediately after the oxidizing agent was thus added to the aniline aqueous solution, the color of the aniline aqueous solution turned dark green. Thereafter, the solution was continuously stirred, whereby generation of a dark green solid began.

After the oxidizing agent was added in 80 minutes in this manner, the resulting reaction mixture containing the reaction product thus generated was cooled, and further stirred for 100 minutes. Thereafter, the resulting solid was suction-filtered through No. 2 filter paper (available from ADVANTEC Corporation) with the use of a Buchner funnel and a suction bottle to provide powder. The powder was washed in an about 2 mol/L tetrafluoroboric acid aqueous solution with stirring by means of the magnetic stirrer, then washed in acetone several times with stirring, and suction-filtered. The resulting powder was dried in vacuum at a room temperature (25° C.) for 10 hours. Thus, 12.5 g of an electrically conductive polyaniline containing tetrafluoroboric acid as a dopant was provided, which was bright green powder.

### (Electrical Conductivity of Electrically Conductive Polyaniline Powder)

After 130 mg of the electrically conductive polyaniline powder was milled in an agate mortar, the resulting powder was compacted into an electrically conductive polyaniline disk having a diameter of 13 mm and a thickness of 720 μm in vacuum at a pressure of 75 MPa for 10 minutes by means of a KBr tablet forming machine for infrared spectrum measurement. The disk had an electrical conductivity of 19.5 S/cm as measured by Van der Po's quad-terminal electrical conductivity measurement method.

### (Preparation of Electrically Conductive Polyaniline Powder in Dedoped State)

The electrically conductive polyaniline powder provided in the doped state in the aforementioned manner was put in a 2 mol/L sodium hydroxide aqueous solution, and stirred in a 3-L separable flask for 30 minutes. Thus, the electrically conductive polyaniline powder was dedoped with the tetrafluoroboric acid dopant through a neutralization reaction. The dedoped polyaniline was washed with water until the filtrate became neutral. Then, the dedoped polyaniline was washed in acetone with stirring, and suction-filtered through No. 2 filter paper with the use of a Buchner funnel and a suction bottle. Thus, dedoped polyaniline powder was provided on the No. 2 filter paper. The resulting powder was dried in vacuum at a room temperature for 10 hours, whereby brown dedoped polyaniline powder was provided.

### (Preparation of Polyaniline Powder in Reduced Dedoped State)

Next, the polyaniline power prepared in the dedoped state in the aforementioned manner was put in a phenylhydrazine methanol aqueous solution, and reduced for 30 minutes with stirring. Due to the reduction, the color of the polyaniline power turned from brown to gray. After the reaction, the resulting polyaniline powder was washed with methanol and then with acetone, filtered, and dried in vacuum at a room temperature. Thus, reduced dedoped polyaniline was provided.

The resulting powder had a median diameter of 13 μm as measured by a light scattering method by using acetone as a solvent.

### (Electrical Conductivity of Reduced Dedoped Polyaniline Powder)

After 130 mg of the reduced dedoped polyaniline powder was milled in an agate mortar, the resulting powder was compacted into a reduced dedoped polyaniline disk having a thickness of 720 μm in vacuum at a pressure of 75 MPa for 10 minutes by means of a KBr tablet forming machine for infrared spectrum measurement. The disk had an electrical conductivity of 5.8×10⁻³ S/cm as measured by Van der Po's quad-terminal electrical conductivity measurement method. This means that the polyaniline compound was an active substance compound having an electrical conductivity variable due to ion insertion/desertion.

### <Preparation of Polycarboxylic Acid>

In ion-exchanged water, 4.4 g of polyacrylic acid (available from Wako Pure Chemical Industries, Ltd., and having a weight average molecular weight of 1,000,000) was dissolved, whereby 20.5 g of a viscous polyacrylic acid aqueous solution having a concentration of 4.4 wt % was provided. Then, 0.15 g of lithium hydroxide was added to and dissolved in the resulting polyacrylic acid aqueous solution, whereby a polyacrylic acid-lithium polyacrylate composite solution was prepared in which 50% of acrylic acid portions were lithium-exchanged.

### <Preparation of Separator>

A nonwoven fabric (TF40-50 available from Hohsen Corporation and having a void percentage of 55%) was prepared.

### <Preparation of Negative Electrode>

Metal lithium (coin-shaped metal lithium available from Honjo Metal Co., Ltd.) having a thickness of 50 μm was prepared.

### <Preparation of Electrolytic Solution>

An ethylene carbonate/dimethyl carbonate solution containing lithium tetrafluoroborate (LiBF₄) at a concentration of 1 mol/dm³ (available from Kishida Chemical Co., Ltd.) was prepared.

### <Tab Electrodes>

A 50-μm thick aluminum metal foil was prepared as a current extraction tab electrode for the positive electrode, and a 50-μm thick nickel metal foil was prepared as a current extraction tab electrode for the negative electrode.

### <Current Collectors>

A 30-μm thick aluminum foil was prepared as a positive electrode current collector, and a 180-μm thick stainless steel mesh was prepared as a negative electrode current collector.

Positive electrode slurries were each prepared for production of the positive electrode by using the materials prepared in the aforementioned manner.

### [Slurry for Example 1: 1-mm Milling Balls]

After 4 g of the polyaniline powder, 0.5 g of electrically conductive carbon black (DENKA BLACK available from Denki Kagaku Kogyo K.K.) and 4 g of water were mixed together, the resulting mixture was added to 20.5 g of the polyacrylic acid/lithium polyacrylate composite solution. The resulting mixture was stirred at a rotation speed of 400 rpm for 1 hour by means of a planetary centrifugal ball mill (P-6 available from Fritsch Gmbh) with the use of 1-mm zirconia milling balls. The amount of the milling balls was 20% of the volume of a container (where a 250-ml container was used, for example, the amount of the balls was 50 ml (i.e., 300 g of balls each having a specific gravity of 6 g/cc were used) as recommended by the maker. After the zirconia balls were separated from the slurry, the slurry was defoamed for 3 minutes by means of THINKY MIXER (available from Thinky Corporation).

### [Slurry for Example 2: 2-mm Milling Balls]

A positive electrode slurry was prepared in substantially the same manner as the slurry for Example 1, except that 2-mm milling balls were used instead of the 1-mm milling balls used for the preparation of the slurry for Example 1 in the same weight (300 g) and the same volume (50 ml) for the ball mill kneading.

### [Slurry for Example 3: 0.5-mm Milling Balls]

A positive electrode slurry was prepared in substantially the same manner as the slurry for Example 1, except that 0.5-mm milling balls were used instead of the 1-mm milling balls used for the preparation of the slurry for Example 1 in the same weight (300 g) and the same volume (50 ml) for the ball mill kneading.

### [Slurry for Example 4: 1-mm Milling Balls]

After 4 g of the polyaniline powder was added to 20.5 g of the polyacrylic acid/lithium polyacrylate composite solution, the resulting mixture was stirred at a rotation speed of 400 rpm for 1 hour with the use of 1-mm zirconia milling balls in the same manner as in Example 1. The zirconia balls were separated from the slurry, and then the resulting slurry was defoamed for 3 minutes by means of THINKY MIXER (available from Thinky Corporation). After the defoaming, 0.5 g of electrically conductive carbon black (DENKA BLACK available from Denki Kagaku Kogyo K.K.) and 4 g of water were added to and mixed with the defoamed slurry in a mortar. Thus, a positive electrode slurry was prepared.

### [Slurry for Comparative Example 1: Dispersion by FILMIX]

After 4 g of the polyaniline powder, 0.5 g of electrically conductive carbon black (DENKA BLACK available from Denki Kagaku Kogyo K.K.) and 4 g of water were mixed together, the resulting mixture was added to 20.5 g of the polyacrylic acid/lithium polyacrylate composite solution. The resulting mixture was kneaded by a spatula, then ultrasonically treated for 5 minutes by an ultrasonic homogenizer, and treated by means of FILMIX MODEL 40-40 (available from Primix Corporation) to provide a fluid slurry. The slurry was defoamed for 3 minutes by means of THINKY MIXER (available from Thinky Corporation).

### [Slurry for Comparative Example 2: 5-mm Milling Balls]

A positive electrode slurry was prepared in substantially the same manner as the slurry for Example 1, except that 5-mm milling balls were used instead of the 1-mm milling balls used for the preparation of the slurry for Example 1 in the same weight (300 g) and the same volume (50 ml) for the ball mill kneading.

### [Slurry for Comparative Example 3: 0.1-mm Milling Balls]

A positive electrode slurry was prepared in substantially the same manner as the slurry for Example 1, except that 0.1-mm milling balls were used instead of the 1-mm milling balls used for the preparation of the slurry for Example 1 in the same weight (300 g) and the same volume (50 ml) for the ball mill kneading.

### [Slurry for Comparative Example 4: 0.05-mm Milling Balls]

A positive electrode slurry was prepared in substantially the same manner as the slurry for Example 1, except that 0.05-mm milling balls were used instead of the 1-mm milling balls used for the preparation of the slurry for Example 1 in the same weight (300 g) and the same volume (50 ml) for the ball mill kneading.

### [Slurry for Comparative Example 5: 0.03-mm Milling Balls]

A positive electrode slurry was prepared in substantially the same manner as the slurry for Example 1, except that 0.03-mm milling balls were used instead of the 1-mm milling balls used for the preparation of the slurry for Example 1 in the same weight (300 g) and the same volume (50 ml) for the ball mill kneading.

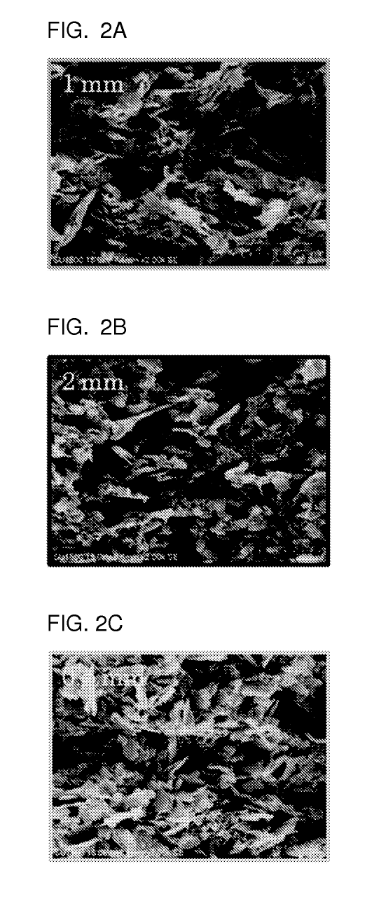

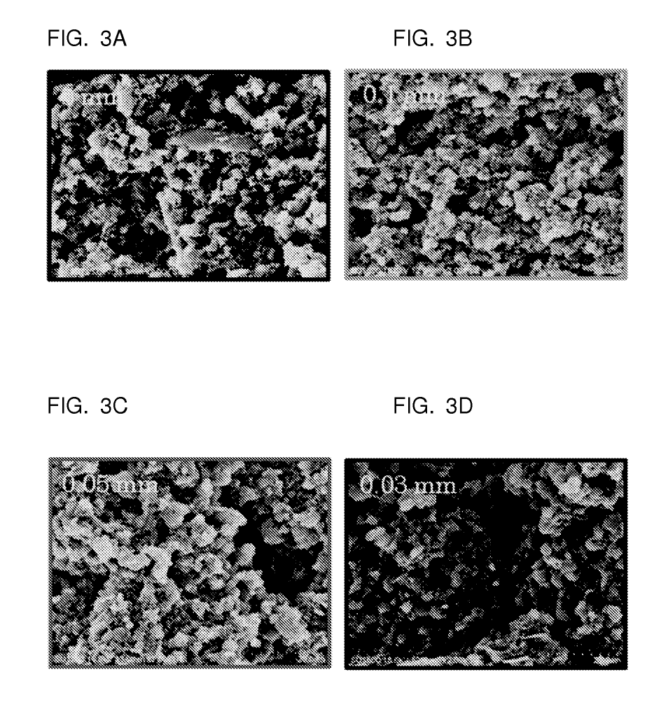

The positive electrode slurries thus prepared were dried, and the resulting dry powdery products were each observed by means of a scanning electron microscope (SEM SU-1500 available from HITACHI Ltd.) FIGS. 2A to 2C are SEM photographs of the dry products of the positive electrode slurries for use in Examples 1 to 3. FIGS. 3A to 3D are SEM photographs of the dry products of the positive electrode slurries for use in Comparative Examples 2 to 5. Comparison between FIGS. 2A to 2C and FIGS. 3A to 3D indicates that the dry products of the positive electrode slurries for use in Examples which each had a finely-split particulate shape (flat shape) are apparently different in shape from the dry products of the positive electrode slurries for use in Comparative Examples which each had a spherical particulate shape.

### Examples 1 to 4 and Comparative Examples 1 to 5

The positive electrode slurries (defoamed pastes) for Examples 1 to 4 and the positive electrode slurries (defoamed pastes) for Comparative Examples 1 to 5 were each applied at a coating rate of 10 mm/sec onto an etched aluminum foil for an electric double layer capacitor (30CB available from Hohsen Corporation) with the use of a desktop automatic coater (available from Tester Sangyo Co., Ltd.) while the coating thickness was adjusted to 360 μm by a doctor blade applicator equipped with a micrometer. Then, the resulting coatings were dried at a temperature of 150° C. for 20 minutes in a drier. Thus, polyaniline sheet electrodes were produced, which were used as the positive electrodes in Examples 1 to 4 and Comparative Examples 1 to 5.

For observation of the shapes of the electrically conductive polymer particles used for each of the positive electrodes, a cured resin product prepared by dispersing a proper amount (which was such that electrically conductive polymer particles present in the photograph were properly dispersed) of the positive electrode slurry in a resin and curing the resulting resin mixture was sliced by an ultrathin slice method, and the resulting ultrathin slice was observed by a transmissive electron microscope (TEM).

In the observation, several regions each having a size of 30 μm×30 μm were photographed by a transmissive electron microscope (H-7650 available from Hitachi High-Tech Corporation), and the average aspect ratio (major diameter/minor diameter) of the electrically conductive polymer particles for each of Examples 1 to 3 and Comparative Example 1 to 5 to be described below in Table 1 was calculated based on the resulting TEM photograph.

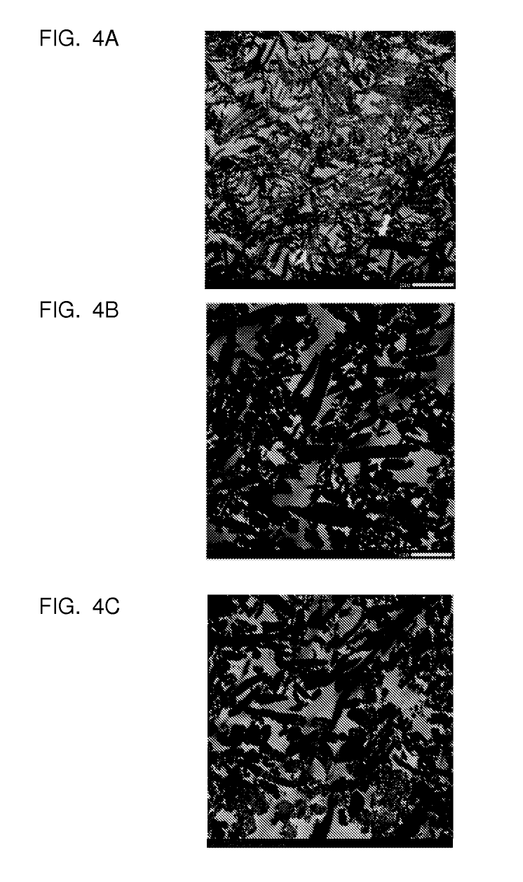

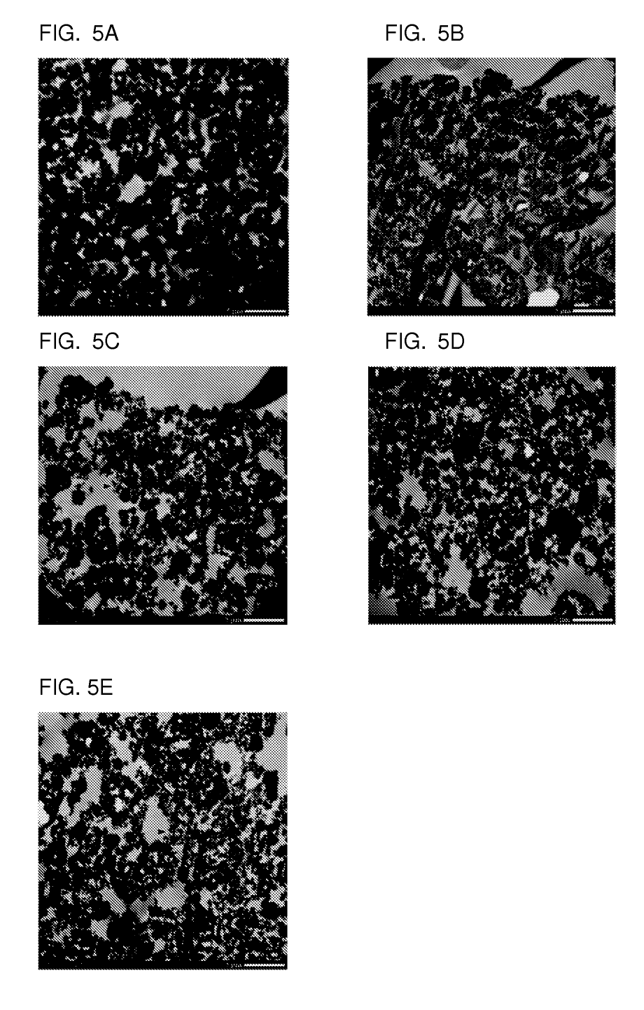

FIGS. 4A to 4C are TEM photographs of sectional surfaces of the cured resin products each prepared by dispersing the positive electrode slurry in the resin for use in Examples 1 to 3. FIGS. 5A to 5E are TEM photographs of sectional surfaces of the cured resin products each prepared by dispersing the positive electrode slurry in the resin for use in Comparative Examples 1 to 5.

Comparison between FIGS. 4A to 4C and FIGS. 5A to 5E indicates that the electrically conductive polymer particles for Examples each had a flat shape having a higher aspect ratio and the electrically conductive polymer particles for Comparative Examples 1 to 5 each had a lower aspect ratio, i.e., a generally spherical shape. Minute spherical particles foggily appearing in FIGS. 4A to 4C and FIGS. 5A to 5E in common are not electrically conductive polymer particles but are the electrically conductive agent (carbon black) which was a constituent of the positive electrode slurry.

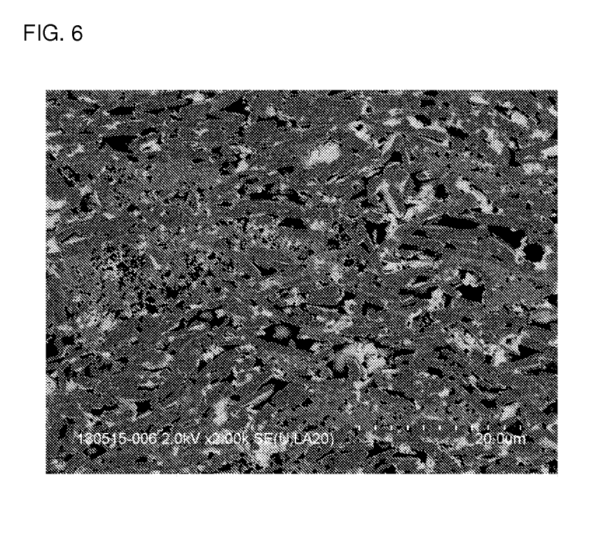

Further, a sectional surface of the positive electrode of Example 4 was observed by means of the SEM (SU-1500 available from HITACHI Ltd.) A SEM photograph of the sectional surface of the positive electrode is shown in FIG. 6. FIG. 6 indicates that the electrically conductive polymer particles in the positive electrode each had a flat shape having a higher aspect ratio as in the other inventive examples.

### <Production of Power Storage Device>

Laminate cells serving as power storage devices (lithium secondary batteries) were each assembled in the following manner by employing the positive electrodes (polyaniline sheet electrodes) produced in Examples 1 to 3 and Comparative Examples 1 to 5 and other materials prepared as described above.

A battery assembling process was performed in a glove box in an ultrapure argon gas atmosphere (having a dew point of −100° C. therein).

The positive electrode for the laminate cell had an electrode size of 27 mm×27 mm, and the negative electrode had an electrode size of 29 mm×29 mm, which was slightly greater than the positive electrode size.

For use, the metal foils of the tab electrodes for the positive electrode and the negative electrode were preliminarily connected to the corresponding current collectors by means of a spot welding machine. The polyaniline sheet electrode (positive electrode) and the stainless steel mesh prepared as the negative electrode current collector were dried in vacuum at 80° C. for 2 hours, and the separator was dried in vacuum at 120° C. for 3 hours. Thereafter, these materials were put in the glove box having a dew point of −100° C. Then, the prepared metal lithium foil was pressed against and squeezed into the stainless steel mesh of the current collector in the glove box, whereby a negative electrode/current collector assembly was produced.

Subsequently, the separator was held between the positive electrode and the negative electrode, and the resulting assembly was put in a laminate pack having three heat-sealed sides. The position of the separator was adjusted so that the positive electrode and the negative electrode were properly opposed to each other without short circuit. Then, a sealant was applied on the positive electrode tab and the negative electrode tab, and the tab electrode portions were heat-sealed with an electrolytic solution inlet port kept open. Thereafter, a predetermined amount of an electrolytic solution was sucked into a micropipette, and fed into the laminate pack through the electrolytic solution inlet port. Finally, the electrolytic solution inlet port provided at an upper portion of the laminate pack was heat-sealed, whereby the laminate cell was completed.

The sizes of the milling balls used in the production of the laminate cells and the average aspect ratios (major diameter/minor diameter) of the particles are shown below in Table 1. The weight capacity density and the initial capacity developing percentage of each of these laminate cells were measured in the following manner, and the results are also shown below in Table 1.

### <Measurement of Weight Capacity Density>

The laminate cells produced in the aforementioned manner were each allowed to stand still in a thermostat chamber kept at 25° C. By means of a battery charge/discharge device (SD8 available from Hokuto Denko Corporation), measurement was performed in a constant current and constant voltage charge/constant current discharge mode. The charge termination voltage was set to 3.8 V. After the voltage reached 3.8 V through a constant current charge process, a constant voltage charge process was further performed at 3.8 V until the current value became 20% of a current value for a constant current discharge process, and the resulting capacity was defined as a charge capacity. Thereafter, the constant current discharge process was performed to a discharge termination voltage of 2.0 V, and a weight capacity density obtained in the second cycle was measured. The weight capacity density was a capacity density per net weight of the electrically conductive polyaniline for use as the positive electrode active substance.

### <Measurement of Initial Capacity Developing Percentage (%)>

The initial capacity developing percentage of each of the laminate cells produced in the aforementioned manner was calculated from the following expression (1), wherein the weight capacity density at the first cycle is a weight capacity density obtained at the first cycle of the five cycles in the measurement of the weight capacity density:

Initial capacity developing percentage (%)=(Weight energy density at first cycle/Weight energy density at fifth cycle)×100 (1)

TABLE 1

| | Example | | | Comparative Example | | | | |
|---|---|---|---|---|---|---|---|---|
| | 1 | 2 | 3 | 1 | 2 | 3 | 4 | 5 |
| Size of milling balls for preparation of | 1-mm | 2-mm | 0.5-mm | FILMIX | 5-mm | 0.1-mm | 0.05-mm | 0.03-mm |
| positive electrode paste | balls | balls | balls | | balls | balls | balls | balls |
| Average aspect ratio of electrically | 5.9 | 5.5 | 5.3 | 1.7 | 1.6 | 1.6 | 1.8 | 1.7 |
| conductive polymer particles | | | | | | | | |
| Weight capacity density (Ah/kg) | 144 | 142 | 148 | 158 | 166 | 152 | 148 | 158 |
| Initial capacity developing percentage | 95.7 | 83.3 | 85.4 | 44.9 | 51.7 | 55 | 58.2 | 52.9 |
| (%) | | | | | | | | |

Table 1 shows that the laminate cells of Examples 1 to 3 each had a higher initial capacity with an initial capacity developing percentage of higher than 80%, and the laminate cells of Comparative Examples 1 to 5 each had a lower initial capacity developing percentage on the order of 40 to 50%. As indicated by the comparison between FIGS. 2A to 2C and FIGS. 3A to 3D and the comparison between FIGS. 4A to 4C and FIGS. 5A to 5E, the flat particles of the electrically conductive polymer significantly contribute to the improvement of the initial capacity developing percentage.

The laminate cell employing the positive electrode of Example 4 also had a higher initial capacity as in Examples 1 to 3.

While specific forms of the embodiment of the present invention have been shown in the aforementioned inventive examples, the inventive examples are merely illustrative of the invention but not limitative of the invention. It is contemplated that various modifications apparent to those skilled in the art could be made within the scope of the invention.

The power storage device can be advantageously used as a lithium secondary battery and other power storage devices. The power storage device can be used for the same applications as the prior art secondary batteries, for example, for mobile electronic apparatuses such as mobile PCs, mobile phones and personal data assistants (PDAs), and for driving power sources for hybrid electric cars, electric cars and fuel battery cars.

### EXPLANATION OF REFERENCES

1 POSITIVE ELECTRODE CURRENT COLLECTOR
2 POSITIVE ELECTRODE
3 ELECTROLYTE LAYER
4 NEGATIVE ELECTRODE
5 NEGATIVE ELECTRODE CURRENT COLLECTOR

1. A power storage device positive electrode comprising particles of an electrically conductive polymer as an active substance, wherein the electrically conductive polymer particles each have a flat shape.

2. The power storage device positive electrode according to claim 1, wherein the electrically conductive polymer particles have an average aspect ratio (major diameter/minor diameter) of 3 to 10.

3. The power storage device positive electrode according to claim 1, wherein the electrically conductive polymer is at least one of a polyaniline and a polyaniline derivative.

4. A power storage device, comprising:
an electrolyte layer; and
a positive electrode and a negative electrode provided in opposed relation with the electrolyte layer interposed therebetween;
wherein the positive electrode comprises, as an active substance, particles of an electrically conductive polymer each having a flat shape.

5. The power storage device according to claim 4, wherein the electrically conductive polymer particles have an average aspect ratio (major diameter/minor diameter) of 3 to 10.

6. The power storage device according to claim 4, wherein the electrically conductive polymer is at least one of a polyaniline and a polyaniline derivative.

7. A method for producing a slurry for a power storage device positive electrode, comprising the step of treating particles of an active substance comprising at least an electrically conductive polymer and a binder by a ball mill process.

8. The method for producing the slurry for the power storage device positive electrode according to claim 7, wherein an electrically conductive agent and water are added to the active substance particles and the binder, and the resulting mixture is treated by the ball mill process.

9. The method for producing the slurry for the power storage device positive electrode according to claim 7, wherein the electrically conductive polymer is at least one of a polyaniline and a polyaniline derivative.

10. The method for producing the slurry for the power storage device positive electrode according to claim 7, wherein milling balls to be used for the ball mill process each have a diameter of 0.2 to 4 mm.
